(19) United States
(12) Patent Application Publication
(10) Pub. No.: US 2011/0308443 A1
(43) Pub. Date: Dec. 22, 2011

(54) Boat docking line, system and method of use

(76) Inventor: Timothy E. Wolf, Queensbury, NY (US)

(21) Appl. No.: 13/218,706

(22) Filed: Aug. 26, 2011

Related U.S. Application Data
(60) Provisional application No. 61/482,312, filed on May 4, 2011.

(51) Int. Cl. B63B 21/00; B23P 11/00

(52) U.S. Cl. 114/230.26; 29/428

(57) ABSTRACT

An improved boat docking line and related method for docking a boat, comprising: a first line section at least three feet in length; a second line section at least three feet in length; a juncture at which the first and second line section meet; and a fixed-circumference docking loop at said juncture. An alternative embodiment further comprises a boat fender attached to the second line section.

### CROSS REFERENCE TO RELATED APPLICATIONS

This application claims priority benefit of pending provisional application U.S. 61/482,312 filed May 4, 2011, which is hereby incorporated by reference.

### BACKGROUND OF THE INVENTION

Under the present conventional standard for docking boats, the U.S. Coast Guard recommends using six (6) lines to safely tie and secure smaller boats of up to about 40 feet, and eight (8) lines for larger boats and yachts. This method is illustrated by prior art FIGS. 1 and 2, for the non-limiting example of docking smaller boats using six (6) lines. In FIG. 1 we see a boat 13 which is freely floating near a dock 16 but which has not yet been docked. The boat contains six (6) standard boat-based docking cleats (boat cleats) 14 affixed thereto, of a type and form which are well known in the art and detailed for completeness in FIGS. 11 and 12. Also illustrated is a swim platform 18, via which boaters should generally enter and exit the boat 13.

Six (6) conventional docking lines 1 are pre-connected at a first end thereof, for example not limitation, to dock-based docking cleats (dock cleats) 17 on a dock 16, or to pylons 15. Pylons typically are actual telephone poles or similar elongate structures which are pounded with a machine deep into the ground under the water until they are secure and stable. These dock cleats 17 and pylons 15 are illustrative, non-limiting examples, of what will generally be referred to herein as mooring fixtures. In addition to being pre-connected to a mooring fixture, each docking line 1 comprises a line section 11 between its first and second end, and a docking loop 12 at its second end, see also FIG. 3. In the exemplary, non-limiting illustration of FIG. 1, we show three dock cleats 17 and three pylons 15, which together provide six (6) mooring fixtures. It is conventional for a docking loop 12 to have a circumference large enough to allow it to readily slip over and securely attach to a boat cleat 14, yet small enough to not come loose so it is retained in place once it has been attached to the boat cleat 14.

While well known in the art, FIGS. 11 and 12 illustrate for completeness, the structural details of a representative boat cleat 14, and two ways in which a docking loop 12 is typically secured to a boat cleat 14. As seen in both FIGS. 11 and 12, a boat cleat 14 typically comprises a broad cleat shoulder 121, a substantially narrower cleat neck 122, and a cleat eye 123 running through cleat neck 122, as illustrated. Shown at the top of cleat shoulder 121 are two unnumbered attachment holes, through which screws or similar attachment devices typically run into order to attach boat cleat 14 at its bottom, to a boat 13. In FIG. 11, the cleat eye 123 is ignored, and the docking loop 12 is simply looped over cleat shoulder 121 and thereafter sits about cleat neck 122, as illustrated. In FIG. 12, one end of docking loop 12 is first threaded through cleat eye 123, and then it is drawn over cleat shoulder 121 and pulled taut, to yield the configuration of FIG. 12. The FIG. 11 configuration is used to secure a boat quickly and easily, for a relatively brief dock stop. The FIG. 12 configuration yields a more secure connection than FIG. 11, and is preferred if the boat is to remain docked for any extended period of time.

One of the problems with the current state of the art is that before a boat 13 has been secured, it is difficult to control the movement of the line sections 11 and docking loops 12, and particularly to control the position of docking loops 12 which need to be grabbed and secured to the boat cleats 14 as in FIGS. 11 and 12. Wind, currents, waves, carelessness by other people, and other vagaries can cause the docking loops 12 to be randomly scattered just about anywhere, as is illustrated in FIG. 1. Thus, when the boat 13 approaches the dock(s) 16, it is often necessary for the operator or another user of the boat to “fish” for the docking loops 12 using a pole preferably with a hook on its end, draw the docking loops 12 over toward the boat 13, and then secure the docking loops 12 to the boat cleats 14. Some of the art to be reviewed momentarily attempts to make this process easier, but in all cases, does so insufficiently.

Once the docking loops 12 have been drawn to the boat 13 and secured to boat cleats 14, the boat 13 is now securely docked, as shown in FIG. 2. At the aft (rear) portion of the boat, the recommended Coast Guard convention is to cross the rear line sections 11, as illustrated in FIG. 2.

There are, however, several problems with this conventional method for docking boats and the docking lines 1 that are used to do so. First, as noted above and highlighted in FIG. 1, the lines 1 cannot be reliably controlled while the boat is undocked, and in particular, it is often necessary to fish around for the docking loops 12. Second, as will be seen in the disclosure to follow, one can obtain a docking connection that is just as secure using half as many lines. Thus, rather than using six (6) lines for smaller boats, one can use three (3) lines. And for larger boats which conventionally require eight (8) lines, one can achieve the same or even better docking stability with only four (4) lines. Third, the configuration of lines 1 using the conventional docking method illustrated in FIG. 2 creates a hazard wherein someone embarking or disembarking the boat 13 may trip over a line section 11, which hazard may be reduced by reducing the number of lines required. Particularly, a person disembarking the boat 13 will typically follow the illustrated egress path 20 across swim platform 18, and in the opposite direction for embarking. This, however, requires that person to step over and across one of the crossed rear lines 1 as illustrated, creating a trip hazard. Fourth, by having only half as many lines, one can save at least half the time ordinarily used in docking a boat, and because the pre-docking positions of docking loops 12 can be reliably controlled, one can actually save well over half the time because the need to go fishing for randomly-situated docking loops 12 is eliminated.

It should also be noted that the average boater puts 50 hours per year on the motor. So if one estimates 5 hours per use for 10 outings a year, this means that they only leave and return to their slip about 10 times per year. This makes docking into their slip even more difficult because they do not practice this very often.

US 2010/0175605 discloses a device for the attachment of a rope to a securing point by a person for mooring a vessel, comprising a support which is configured to releasably attach the rope to the securing point, and an elongate arm which is configured to be grasped at or near an end by the person and is configured such that the support can be attached at or near an opposite end so that attachment to the securing point can be carried out by the person at a distance. The elongate arm and the support attached thereto make it possible to displace a part of the rope at a distance and thus facilitate mooring. All of this appears to be an effort to remedy the “fishing” problem discussed above. However, the elongate arm and support, as well as the non-fixed nature of the rope loop which may be enlarged or reduced, see paragraph [0012], create a system that is unnecessarily complicated and unwieldy. These features of US 2010/0175605 may all be readily omitted to achieve simplified and improved docking capability.

U.S. Pat. No. 5,738,033 discloses a bumper and sling arrangement which assists a user to dock his or her boat to a dock or the like by allowing the user to set-up the sling in slack condition between moorings on the boat and dock, and then allowing the user to tighten the slackness out of the sling until the boat is pulled into the dock. As will be seen, it is superior to start out from a tighter configuration with fixed-circumference loops in relatively controlled positions for securing to the boat cleats 14, without requiring slack adjustment.

U.S. Pat. Nos. 7,100,527 and 2006/0042533 show a crossed-line system for mooring, implemented in an unnecessarily cumbersome manner, without a fixed-circumference loop in controlled position. U.S. Pat. Nos. 2,919,671, 5,575,234 and 5,937,780 also show mooring configurations of general background interest, also without a fixed-circumference loop in controlled position.

U.S. Pat. Nos. 6,295,943 and 3,181,861, which are for towing a boat, are of background interest.

U.S. Pat. No. 4,656,961 illustrates a mooring system with two points of contact on a boat and one on the dock, and with no apparent fixed-circumference loop.

U.S. Pat. Nos. 7,891,058; 5,586,514 and 4,912,816 are of interest because they depict docking loops, in general.

U.S. Pat. No. 6,273,017 shows a line at the cleat branching off in two directions. But, it has no apparent fixed-circumference loop and has other features that are unnecessarily complicating. U.S. Pat. Nos. 5,265,553 and 3,492,963 provide similar background disclosure.

U.S. Pat. No. 7,673,577 is an example of another mooring system.

Finally, U.S. Pat. No. 7,007,622 is a fender system which is also part of a mooring system.

It would be desirable to have available an improved boat docking line, system and method of use which overcomes the earlier-mentioned problems and achieves all of the earlier-mentioned objectives, in a way that is not yet satisfactorily achieved by the prior art.

### SUMMARY OF THE INVENTION

An improved boat docking line and related method for docking a boat, comprising: a first line section at least three feet in length; a second line section at least three feet in length; a juncture at which the first and second line section meet; and a fixed-circumference docking loop at the juncture. An alternative embodiment further comprises a boat fender attached to the second line section.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 is an overhead view illustrating some of the problems with the prior art, wherein the lines and docking loops used to dock a boat are often randomly scattered in position and so need to be fished into the boat before the boat can be docked.

FIG. 2 is an overhead view illustrating a boat docked in accordance with prior art docking lines and methods, in a six (6) line configuration as is recommended by the US Coast Guard for smaller boats.

FIG. 3 is a plan view illustrating a prior art docking line.

FIG. 4 is a plan view illustrating an improved boat docking line in accordance with a preferred embodiment of the invention.

FIG. 5 is a plan view illustrating and alternative embodiment of the improved boat docking line of FIG. 4, also comprising a fender for preventing a boat from colliding against a dock.

FIG. 6 is an overhead view illustrating three of the improved boat docking lines of FIG. 4 while a boat has pulled up near a dock but has not yet been docked. In contrast to FIG. 1, the lines and docking loops are not randomly scattered but are in controlled positions and easily gathered for attachment to the onboard boat cleats.

FIG. 7 is an overhead view illustrating the boat of FIG. 6 once it has been docked using these improved boat docking lines. The three illustrated lines do not allow the vessel once secured to touch any fixed structures, and so avoid damage to either the boat or the fixed structures.

FIG. 8 is an overhead view illustrating a boat docked using the improved boat docking line plus boat fender, of FIG. 5, wherein the boat is secured to the dock along with a fender between them to prevent possible damage.

FIG. 9 is a side view illustrating a dock with the improved boat docking line embodiment of FIG. 4 attached to dock posts where the lines are not floating in the water and easy to reach when a user leaves or returns to their assigned slip.

FIG. 10 is a side view illustrating a dock with the improved boat docking line embodiments of both FIGS. 4 and 5 attached to dock posts.

FIG. 11 is a perspective view illustrating the structural details of a representative boat cleat, and one way in which a docking loop is typically secured thereto, both in the prior art, and in accordance with this invention.

FIG. 12 is a perspective view illustrating the same boat cleat as in FIG. 11, and a second way in which a docking loop is typically secured thereto, both in the prior art, and in accordance with this invention.

### DETAILED DESCRIPTION

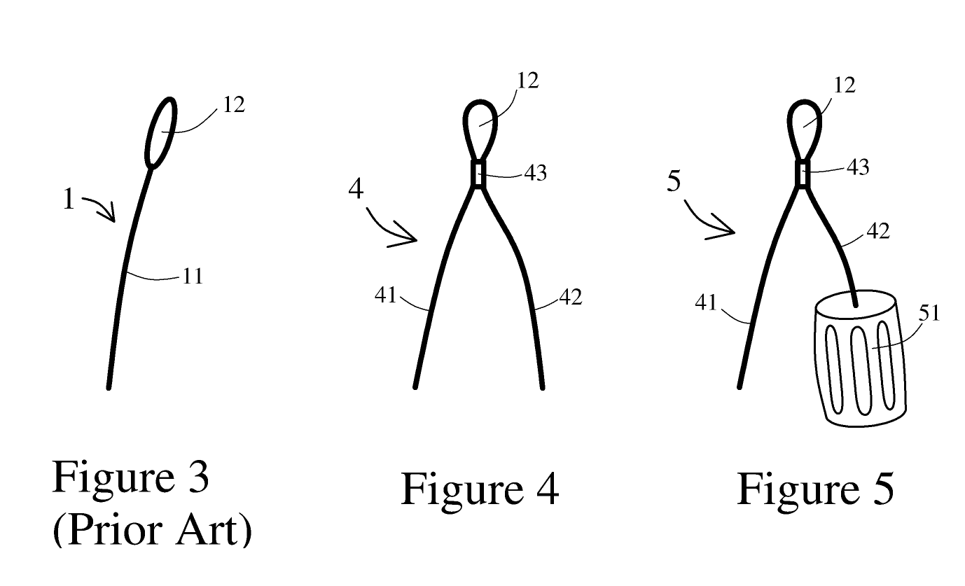

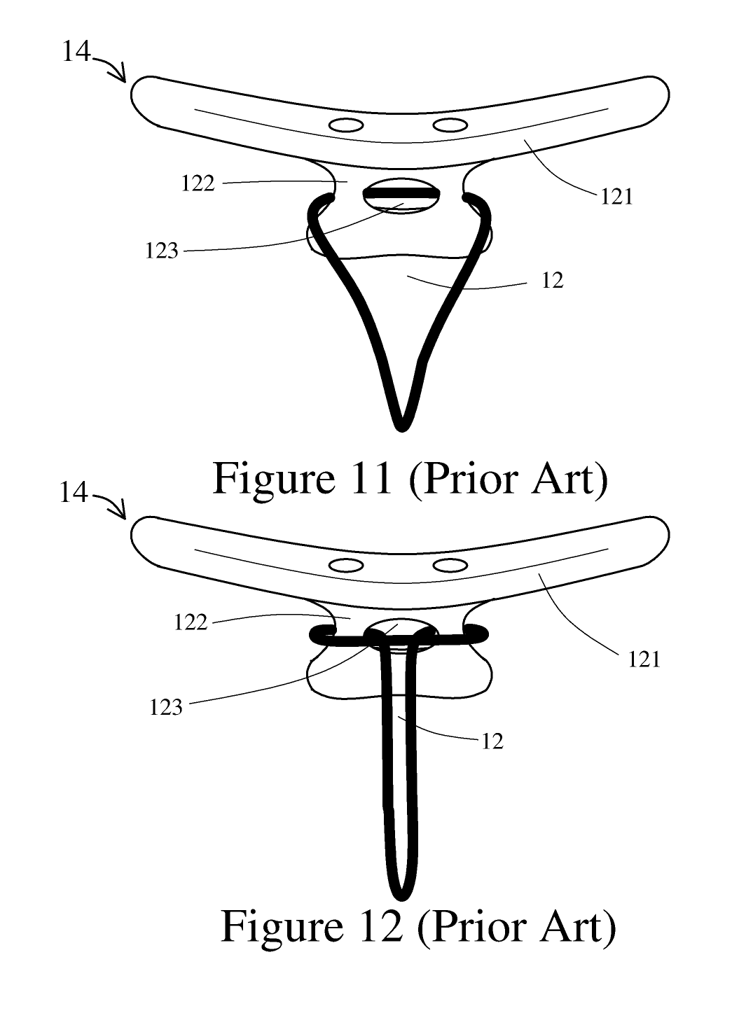

As is now illustrated in FIG. 4, in a preferred embodiment of the invention, the conventional docking line 1 of FIG. 3 is replaced by a novel and inventive improved boat docking line 4 which is attached to docks and boats in the manner to be described below. This improved boat docking line 4 comprises a docking loop 12 substantially similar to the docking loop of conventional docking line 1, securable to boat cleats 14 in substantially the same way as is illustrated in FIGS. 11 and 12. However, rather than having a single line section 11, this improved boat docking line 4 comprises a pair of line sections, namely, a first line section 41 and a second line section 42 joined 43 proximate docking loop 12, in the sort of “wishbone” configuration illustrated in FIG. 4. Docking loop 12 is to be fixed in circumference, which means that this docking loop cannot be either enlarged or reduced in its circumference, in contrast to the rope loop in US 2010/0175605 for which enlargement and reduction are an integral part of that invention.

The terms “first” and “second” as used here make no intrinsic distinction between these two line sections 41, 42, but are merely a convenient nomenclature used for the sake of this disclosure. The “free” ends of docking line 4, i.e., the ends of first line section 41 and second line section 42 which are distal relative to docking loop 12, and which are illustrated at the bottom of FIG. 4, are to be attached to substantially fixed mooring fixtures, e.g., dock cleats 17 and/or pylons 15 and/or posts 91, as will be developed in connection with FIGS. 6, 9 and 10.

While FIG. 4 illustrates first line section 41 and second line section 42 tightly contained within a sleeve at the juncture 43 so as to form docking loop 12 at juncture 43, such a sleeve is merely an example of how to fabricate improved boat docking line 4 into the illustrated configuration. First line section 41 and second line section 42 may, for example, not limitation, be woven or sewn together, or roped together, or glued together, or fastened together in any other manner apparent to those of ordinary skill in the art, so as to form docking loop 12 at juncture 43 with a fixed circumference. While it is preferred and easier to fabricate improved boat docking line 4 if docking loop 12 is continuous with the same rope as first line section 41 and second line section 42, it is even possible within the scope of this disclosure and its associated claims to have docking loop 12, during fabrication, start out as separate from first line section 41 and second line section 42, and be joined to them by any suitable attachment means apparent to one of ordinary skill in the art. Similarly, while first line section 41 and second line section 42 are preferably part of a continuous section of rope prior to fabrication, this too is not a requirement, and any other means of creating the necessary attachments to yield the configuration of FIG. 4 is regarded to be within the scope of this disclosure and its associated claims. In the most general terms, independent of specific implementation, improved boat docking line 4 comprises a first line section 41, a second line section 42, a juncture 43 at which the first 41 and second 42 line sections meet, and a fixed-circumference docking loop 12 at juncture 43.

While FIG. 4 shows first line section 41 and second line section 42 being of approximately equal lengths, this is not a requirement. In fact, in many cases, unequal lengths as between first line section 41 and second line section 42 may be desirable. In general, the length of each of first line section 41 and second line section 42 will be determined by the particular manner in which they will be employed for docking, as will be discussed further below. But as a general rule for virtually all cases of practical boating interest, first line section 41 and second line section 42 will each be at least three (3) feet in length and in most cases at least five (5) feet in length. Common lengths for each of these sections, for most practical boating applications, will range anywhere from three (3) feet up to thirty (30) feet or more, and again, the length of each of these two line sections will be determined by particular boat 13 and dock 16 sizes and configurations and so may be unequal. Standard manufactured lengths for these line sections 41, 42 may be, but are not limited to, for example, 5, 10, 15, 20, 25 or 30 feet. Standard lengths may also be, for example not limitation, 6, 12, 18, 24 and 30 feet. Or, 3, 6, 9, 12, 15, 18, 21, 24, 27 and 30 feet. Again, the optimum length for each line section will all depend on the intended dock 16 requirements and the sizes and heights and layouts of boats 13 expected to be docked, and the overall mooring fixture configuration.

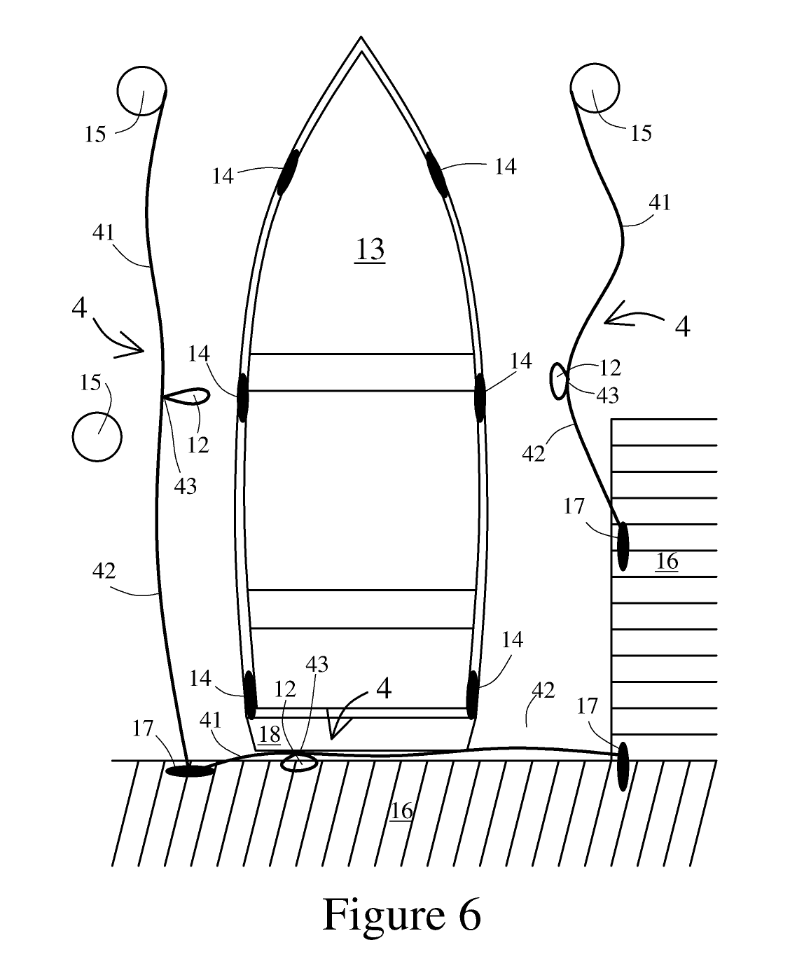

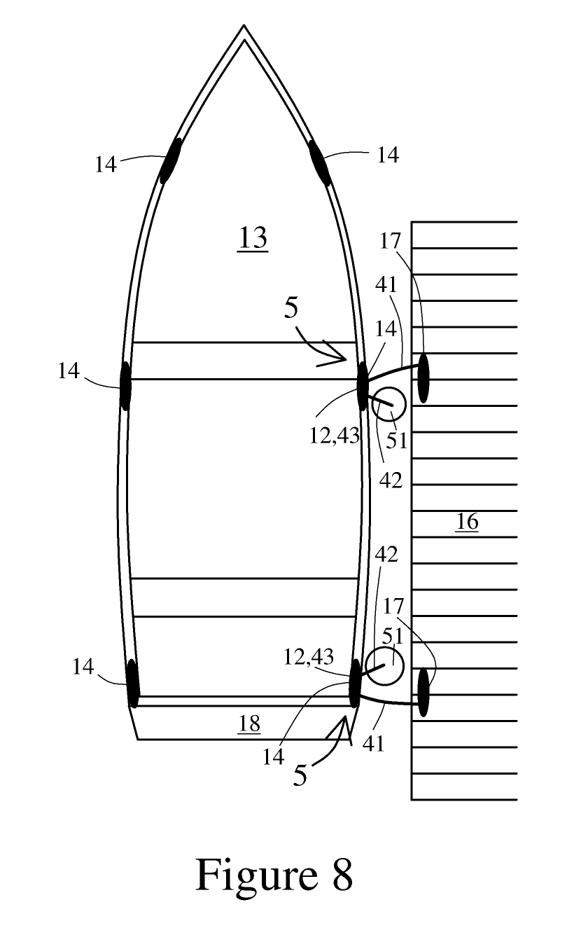

FIG. 5 illustrates a variation of the invention in which the second line section 42 has a conventional boat fender 51 attached thereto. As noted earlier, the terms “first” and “second” as used here make no intrinsic distinction between these two line sections 41, 42, but are merely a convenient nomenclature. However, once a boat fender 51 has been pre-attached to one of these two line sections, then an intrinsic distinction is of course introduced between them. The length of the second line section 42 between docking loop 12 and the top of boat fender 51 will generally range from four (4) to (6) feet and usually five (5) to six (6) feet, with the precise length predominantly dependent on the difference between the height of the boat 13 to be docked and the height of the dock 16 at which boat 13 is to be docked, as will be seen in FIG. 8.

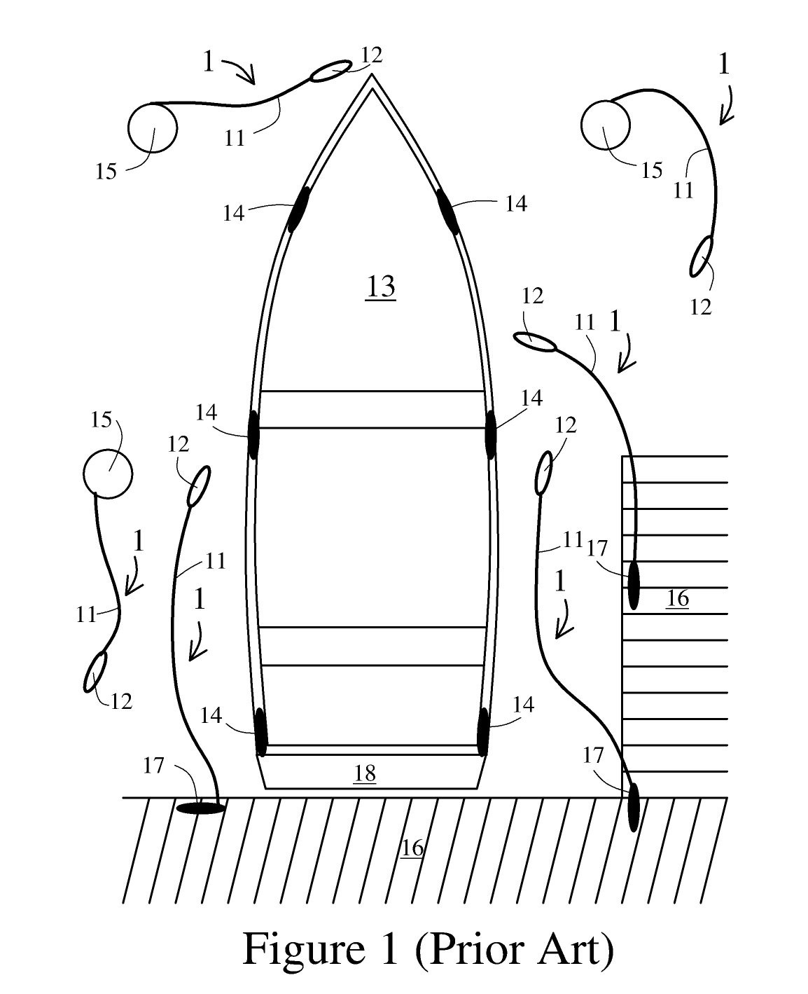

FIG. 6 illustrates three (3) of the improved boat docking lines 4 of FIG. 4 once a boat 13 has pulled up near dock 16 but has not yet been docked. In contrast to FIG. 1, the lines 41, 42 and docking loops 43 are not randomly scattered but are in controllably-situated positions. This will make it much easier to dock the boat 31, because it is not necessary to fish for the docking loops 43. Specifically, in the configuration of FIG. 6, for any given improved boat docking line 4, the free distal ends of both the first line section 41 and the second line section 42 are now in attached to two distinct, substantially fixed, spatially-separated mooring fixtures—in this example, dock cleats 17 or pylons 15—separated from one another by a predetermined fixture separation distance. For any given improved boat docking line 4, the total “free length” of docking line 4, defined as the sum of the lengths of first line section 41 plus second line section 42 once they are attached to the mooring fixtures, is only slightly greater than the predetermined fixture separation distance between the two separated mooring fixtures to which its free distal ends are attached. In fact, as a general rule, for any given improved boat docking line 4, the sum of the free lengths of first line section 41 plus second line section 42 after mooring fixture attachment should be no greater than one-hundred-twenty-five percent (125%) of the predetermined fixture separation distance, which allows for a slack of 25% over the predetermined fixture separation distance. In many cases, if feasible, this total free length number should be one-hundred-twenty percent (120%) (20% slack), one-hundred-fifteen percent (115%) (15% slack) or even as low as one-hundred-ten percent (110%) (10% slack) and in suitable situations, even one-hundred-five percent (105%) (5% slack).

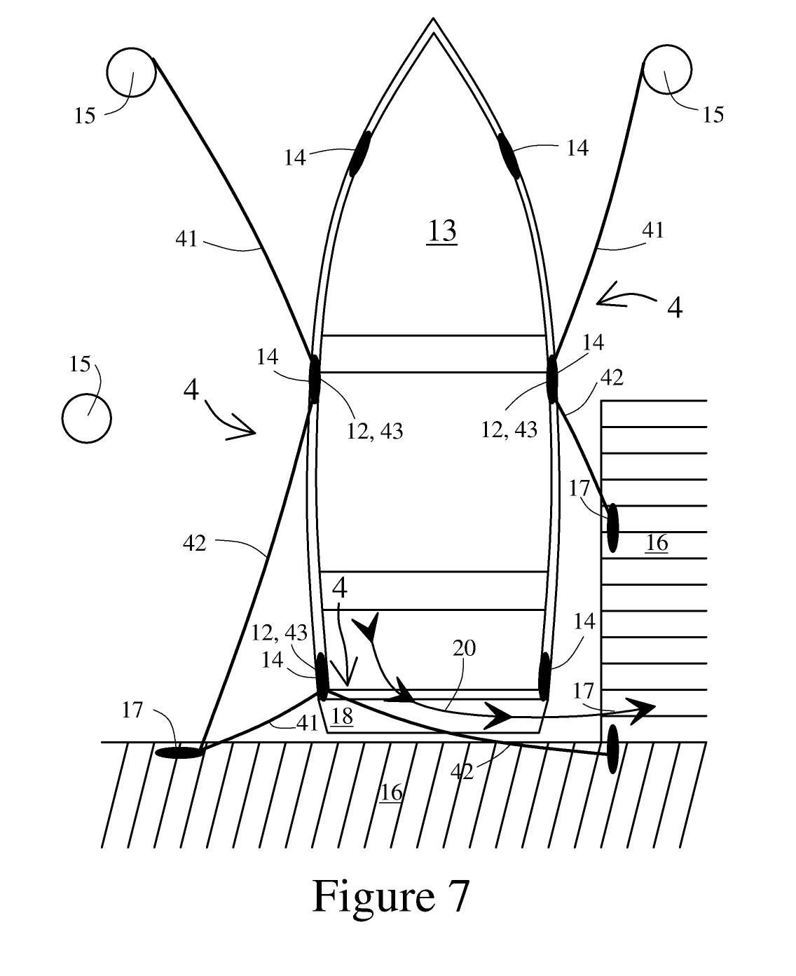

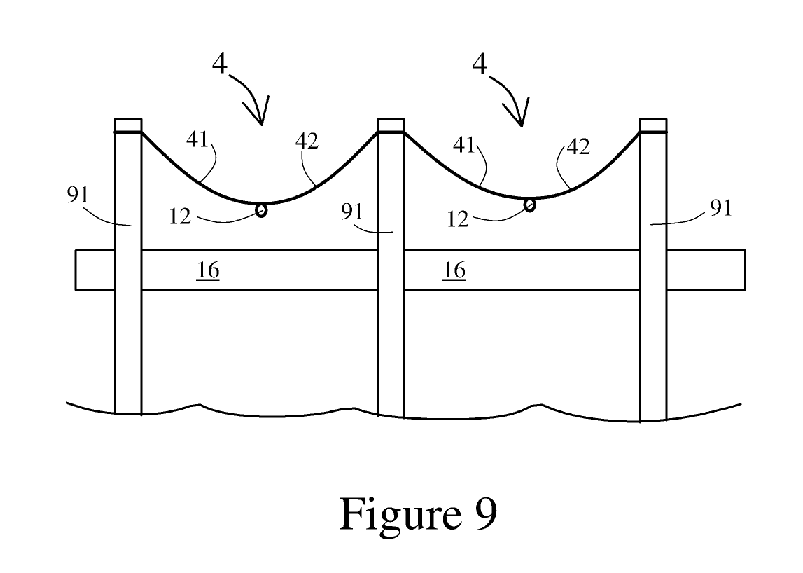

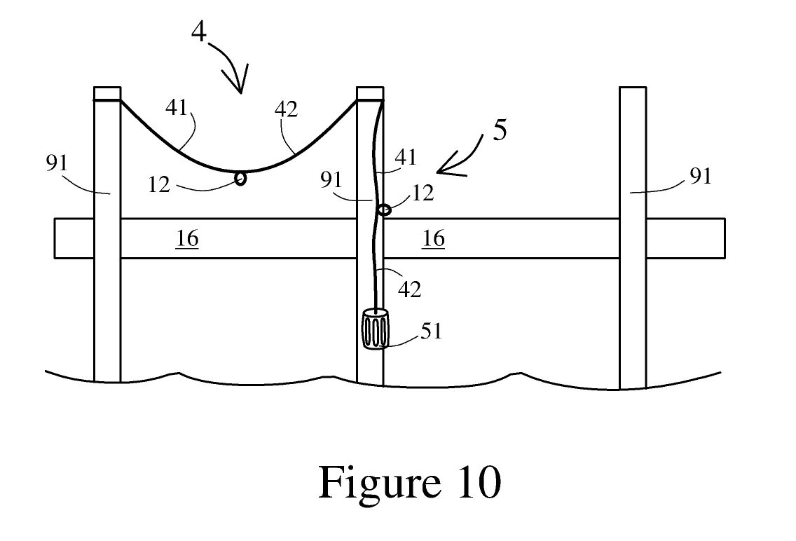

Further, the docking loop 12 is situated so as to be within easy reach (e.g., within five feet) of the particular boat cleats 14 to which it is expected to be attached, as will be seen momentarily in FIG. 7. These two factors—the distance between mooring fixtures, e.g., 15, 17, 91 and the expected positions when docked of the boat cleats 14—are what determine the optimum individual lengths of each of first line section 41 and second line section 42 and the positions of the fixed-circumference docking loop 12 upon improved boat docking line 4. Earlier, we suggested some standard manufactured lengths for first line section 41 and second line section 42. These standard manufactured lengths include whatever line length at the distal ends of first line section 41 and second line section 42 may be necessary for hitching, looping, etc. to mooring fixtures 15, 17, see, for example, FIGS. 9 and 10 in which these line sections are hitched to dock posts 91. But the free first and second line section lengths referred to above, are understood to be the lengths of free line after attachment of the distal ends to mooring fixtures.

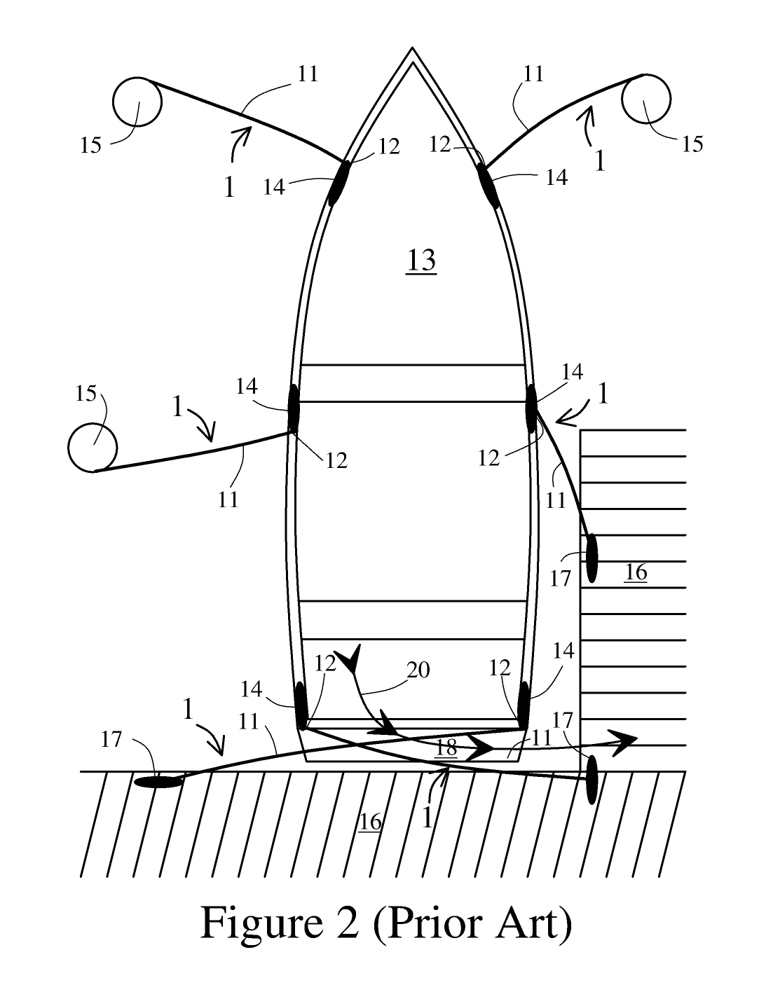

Now we turn to FIG. 7, which shows the boat 13 of FIG. 6 once it has been docked using these improved boat docking lines 4. Contrasting FIG. 7 with FIG. 6, we see that each docking loop 12 can be attached to its associated boat cleat 14—in the manner earlier reviewed in connection with FIGS. 11 and 12—without much fishing, precisely because the improved boat docking lines 4 are configured with such that when the free distal ends of their first line sections 41 and second line sections 42 are attached to two distinct, spatially-separated mooring fixtures, a degree of tautness for docking the boat is preconfigured into the boat docking lines 4 such that their docking loops 12 do not have much play to move around due to wind, currents, waves, carelessness by other people, etc. Once the boat 13 is docked, these improved boat docking lines 4 provide just as secure a connection as a prior art docking line 1, and even more so. In particular, improved boat docking lines 4 secure the boat from unwarranted movement and from collision with the dock 16, because of the pre-docking tautness that is introduced via the configuration of FIG. 6 even before the boat 13 is docked. Put differently, based on the configuration of improved boat docking lines 4, there is a preconfigured tautness already engineered into the configuration of FIG. 6 even before a boat is ever docked, whereas in the prior art as illustrated in FIG. 1, there is no such preconfigured tautness. Rather, the tautness is introduced only after the boat 13 is docked as in FIG. 2, which is not as stable a configuration.

As can now be understood, the foregoing resolves all of the problems mentioned earlier. First, the improved boat docking lines 4 can be reliably controlled while the boat is undocked, and it is not necessary while docking to fish around for the docking loops 12. These loops 12 are substantially in place, in the positions needed, before the boat 13 is docked. Second, one can obtain a docking connection that is just as secure—and even more secure because of the ability to preconfigure the tautness—using half as many lines. Thus, rather than using six (6) prior art lines 1 for a smaller boat, one can use three (3) improved lines 4. And for larger boats which conventionally require eight (8) prior art lines 1, one can achieve the same or even better docking stability with only four (4) improved lines 4. Third, because there are less lines, there is a reduced tripping hazard. For example, not limitation, if a person was to embark or disembark boat 13 from the aft while it is docked as in FIG. 2, that person, as discussed earlier, would have to step over and across one of the two crossed rear lines 1, and so may trip. In FIG. 7, as is illustrated, following the same egress path 20 to disembark (and in the opposite direction to embark), there are no lines to step across, which reduces the tripping hazard. Fourth, by having only half as many lines, one can save at least half the time ordinarily used in docking a boat, and because the docking loops 12 can be reliably controlled and preconfigured with just the desired amount of tautness and their positions predetermined, one can actually save well over half the time because the need to go fishing for randomly-situated docking loops 12 is eliminated.

In fact, to establish the preconfigured tautness, if it is known that the same boat 13 or boats of similar configurations are to always be docked at the dock 16, then the very first time such a boat 13 is docked, one would carefully adjust all of the attachments of the distal ends of all the line sections 41, 42 to the mooring fixtures to achieve the precisely desired boat position with the precisely desired line tautness and the precisely desired positions of docking loops 12. Then, once the boat 13 is released by disengaging docking loops 12 from boat cleats 14, this adjustment will have been “memorized,” i.e., built in, so that when the boat returns, everything will be precisely situated to ensure optimum, uniformly preconfigured and repeatable docking, time after time.

It is also possible to consider embodiments in which the docking loop 12—while fixed in circumference—can be slidably repositioned along improved boat docking line 4 without disconnecting the line sections 41, 42 from the mooring fixtures, to accommodate different boats with different boat cleat 14 positions. That is, the tautness can be separated from docking loop 12 position, so that improved boat docking line 4 always retains the necessary tautness that is needed regardless of which boat may be docked, but the docking loop 12 position may be altered to accommodate possibly-varying boat cleat 14 positions from one boat to the next.

FIG. 8 illustrates boat 13 docked using the improved boat docking line plus fender embodiment 5 which was illustrated in FIG. 5. In this alternative embodiment of the invention, first line sections 41 are used to attach the boat cleats 14 to mooring fixtures such as but not limited to the illustrated dock cleats 17, by attaching docking loops 12 to boat cleats 14 in the manner of FIGS. 11 and 12 while the distal ends of the first line sections 41 remain pre-attached to the mooring fixtures. However, boat fenders 51 in this embodiment are pre-attached to second line sections 42 (really, to the “other” line section given that “first” and “second” are just nomenclature) at a length of about four (4) to six (6) feet from the docking loops 12, with the precise length predominantly predetermined based upon the boat 13 height. In particular, the length of the second line section 42 between the docking loop 12 and the boat fender 51 will be chosen such that the fender will reside between the side of the boat 13 and the dock 16 with the second line section 42 hanging down in a substantially vertical orientation, when the docking loop 12 is attached to a boat cleat 14. Thus, this length will be chosen predominantly depending on the height of the boat 13 relative to the dock 16, and secondarily on the positions of the boat cleats 14 and how far they are from the edge of the boat 13 because of the extra line length that may be needed if the boat cleat 14 is substantially set back from the edge of the boat 13. In other words, the length of said second line section 42 between docking loop 12 and boat fender 51 is substantially equal to the difference between a height of the boat 13 to be docked and a height of the dock 16 at which the boat is to be docked, plus a setback from the edge of the boat 13, if any, of the boat cleat 14 to which docking loop 12 is to be attached.

Thus, while docking loops 12 are attached to boat cleats 14, the boat fenders 51 will naturally take their place between the boat 13 and the dock 16, so as to prevent the boat 13 from collisions with the dock 16, which is the reason for using boat fenders. That is, using the improved boat docking line plus fender embodiment 5 of FIG. 5, the very act of looping docking loops 12 over boat cleats 14 so as to secure boat 13 to the dock 16—with the second line section 42 length correctly predetermined relative to the boat 13 height and any boat cleat 14 setbacks—simultaneously causes the boat fenders 51 to situate between the boat 13 and the dock 16 so as to protect the side of the boat 13 from colliding with the dock 16. So this embodiment enables simultaneous docking and fender placement by the single act of looping docking loops 12 over boat cleats 14.

In the same manner that was described above for FIG. 7, if it is known that the same boat 13 or boats of similar configurations are to always be docked at the dock 16, then the very first time such a boat 13 is docked, one would adjust the length(s) of second line section(s) 42 to ensure that optimum position(s) for the boat fender(s) 51. Thereafter, this position will again be built in by “memory,” so that any time such a boat 13 is subsequently, docked, the boat fender(s) 51 will always fall into the proper position once the docking loops 12 are attached to the boat cleats 14. A slidable/adjustable boat fender position may be considered, if it is anticipated that boats of different heights will need to be docked.

FIG. 9 is a side view of a dock 16 with the improved boat docking line embodiment 4 of FIG. 4 attached to dock posts 91. These dock posts 91 are another type of illustrative mooring fixture. We see the docking loops 12 controllably prepositioned so that when a boat 13 arrives for docking, a person on the boat needs to merely reach over, grab the docking loops 12, and attached them to the boat cleats 14 as in FIGS. 11 and 12, much as was discussed in connection with FIGS. 6 and 7. Docking the boat becomes a simple, uniform, repeatable procedure, time after time.

FIG. 10 illustrates a dock with the improved boat docking line embodiment of both FIGS. 4 and 5 attached to dock posts 91. In particular, the improved boat docking line embodiment 5 of FIG. 5 is shown attached to the middle dock post 91. When a boat 13 arrives for docking, the position of docking loop 12 is similarly controlled, while boat fender 51 hangs down below loop 12. A person on the boat merely reaches over, grabs the docking loop 12, and loops it over a boat cleat 14, much as was discussed in connection with FIG. 8. As this happens—with the length of second line section 42 properly predetermined—the boat fender 51 will simultaneously continue to hang down to become situated in the proper position between the boat 13 and the dock 16 to prevent collisions between the boat 13 and the dock 16.

Throughout this disclosure, we have illustrated the use of improved boat docking lines 4 for docking smaller boats 13 which are conventionally docked using six (6) conventional lines 1 and can now be docked with only three (3) improved boat docking lines 4. As noted earlier, these are boats 13 up to about 50 feet according to current Coast Guard standards. Larger boats conventionally require eight (8) lines 1, which can now be replaced by only four (4) improved boat docking lines 4, using these improved boat docking lines 4 in the same way as in FIGS. 6 and 7, but with two (2) additional mooring fixtures and one (1) additional boat cleat 14 added in a straightforward manner. Thus, while the illustrations in FIGS. 1, 2, 6 and 7 here show a six-conventional/three-improved line docking configuration, it is understood that the eight-conventional line 1 docking configuration for larger boats, which is replaced by a four improved line 4 configuration using this invention, is also within the scope of this disclosure and its associated claims, as are other variations that would be apparent to someone of ordinary skill in the art even if not in compete accordance with Coast Guard recommendations. That is, nothing in this disclosure is intended to be limited to six line or eight line conventional configurations as now replaced by three line or four line improved configurations. Any use of any number of improved boat docking lines 4 and 5 to dock a boat, is understood to be within the scope of this disclosure and its associated claims.

Similarly, while the illustrations here show a particular docking configuration with a particular configuration of mooring fixtures, it is to be understood that this is merely illustrative, and that all manner of docking variations for docks and mooring fixtures in an unlimited variety of configurations and positions are also understood to be within the scope of this disclosure and its associated claims. This would include situations where a boat is held in a stable position only by mooring fixtures, e.g., pylons 15, situated in the middle of a body of water away from any nearby docks 16.

Finally, while the use of the wishbone embodiment of FIG. 4 was illustrated in FIGS. 6 and 7 while the use of fender embodiment of FIG. 5 was shown in FIG. 8, this should not be taken to in any way suggest that these two embodiments are mutually exclusive. It is fully envisioned that in a given situation, a boat user and/or dock manager may find it helpful to make use of both the FIG. 4 and the FIG. 5 embodiments in whatever mix and match configuration that individual regards as helpful to his or her particular docking requirements in relation to the size and height and layout of the boats in question. FIG. 10 is an example in which both embodiments are simultaneously employed.

At bottom, this disclosure and its associated claims envisions that the wishbone embodiment 4 of FIG. 4 and the fender embodiment 5 of FIG. 5 both will become part of the repertoire of equipment available to a boater and/or a dock manager, to be deployed in whatever manner they determine is necessary in any given circumstance to facilitate easy, quick, safe, secure, and uniformly-replicable “memorized” docking, and to protect boats and docks from collision damage.

The knowledge possessed by someone of ordinary skill in the art at the time of this disclosure is understood to be part and parcel of this disclosure and is implicitly incorporated by reference herein, even if in the interest of economy express statements about the specific knowledge understood to be possessed by someone of ordinary skill are omitted from this disclosure. While reference may be made in this disclosure to the invention comprising a combination of a plurality of elements, it is also understood that this invention is regarded to comprise combinations which omit or exclude one or more of such elements, even if this omission or exclusion of an element or elements is not expressly stated herein, unless it is expressly stated herein that an element is essential to applicant's combination and cannot be omitted. It is further understood that the related prior art may include elements from which this invention may be distinguished by negative claim limitations, even without any express statement of such negative limitations herein. It is to be understood, between the positive statements of applicant's invention expressly stated herein, and the prior art and knowledge of the prior art by those of ordinary skill which is incorporated herein even if not expressly reproduced here for reasons of economy, that any and all such negative claim limitations supported by the prior art are also considered to be within the scope of this disclosure and its associated claims, even absent any express statement herein about any particular negative claim limitations.

Finally, while only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. An improved boat docking line for docking a boat, comprising:
a first line section at least three feet in length;
a second line section at least three feet in length;
a juncture at which said first and second line sections meet; and
a fixed-circumference docking loop at said juncture.

2. The improved boat docking line of claim 1, wherein:
when said first line section is attached to a first mooring fixture and said second line section is attached to a second mooring fixture spatially separated from the first mooring fixture by a predetermined fixture separation distance, a sum of a free length of said first line section plus a free length of said second line section length is no greater than one-hundred-twenty-five percent (125%) of said fixture separation distance; whereby:
a desired tautness for docking the boat is preconfigured into said boat docking line.

3. The improved boat docking line of claim 2, wherein said docking loop is positioned within five feet of an expected location of a boat cleat to which said docking loop is to be attached when the boat comprising the boat cleat is docked, whereby said docking loop is maintained in a controllably-situated position even while the boat is not docked.

4. The improved boat docking line of claim 1, further comprising omitting a support configured to attach the improved boat docking line to a mooring fixture.

5. The improved boat docking line of claim 4, further comprising omitting an elongate arm configured to be grasped at or near a proximal end by a person and configured such that said omitted support can be attached at or near an opposite distal end so that attachment to the mooring fixture can be carried out by the person at a distance from the mooring fixture.

6. The improved boat docking line of claim 1, wherein:
said first line section is attached to a first mooring fixture; and
said second line section is attached to a second mooring fixture spatially separated from the first mooring fixture by a predetermined fixture separation distance.

7. The improved boat docking line of claim 6, wherein said the improved boat docking line is preconfigured for uniformly-repeatable docking by having attached said docking loop to a boat cleat of the boat while the boat was situated at a dock at which the boat is to be docked, before said first line section was attached to the first mooring fixture and before said second line section was attached to the second mooring fixture, such that said first line section was attached to the first mooring fixture and said second line section was attached to the second mooring fixture with a desired preconfigured tautness.

8. The improved boat docking line of claim 6, wherein a sum of a free length of said first line section plus a free length of said second line section length is no greater than one-hundred-twenty-five percent (125%) of said fixture separation distance; whereby:
a desired tautness for docking the boat is preconfigured into said boat docking line.

9. The improved boat docking line of claim 8, wherein said docking loop is positioned within five feet of an expected location of a boat cleat to which said docking loop is to be attached when the boat comprising the boat cleat is docked, whereby said docking loop is maintained in a controllably-situated position even while the boat is not docked.

10. The improved boat docking line of claim 8, wherein said docking loop is attached to boat cleat of the boat, such that said improved boat docking line tautly maintains a stable position for the docked boat due to said sum of said free lengths and said position of said docking loop at said juncture.

11. The improved boat docking line of claim 9, wherein said docking loop is attached to boat cleat of the boat, such that said improved boat docking line tautly maintains a stable position for the docked boat due to said sum of said free lengths and said position of said docking loop at said juncture within five feet of the expected location of the boat cleat, whereby said docking loop is maintained in a controllably-situated position even while the boat is not docked.

12. A method for docking a boat using an improved boat docking line, comprising:
providing an improved boat docking line comprising: a first line section at least three feet in length; a second line section at least three feet in length; a juncture at which said first and second line sections meet; and a fixed-circumference docking loop at said juncture;
attaching said first line section to a first mooring fixture; and
attaching said second line section to a second mooring fixture spatially separated from the first mooring fixture by a predetermined fixture separation distance.

13. The method of claim 12, further comprising:
preconfiguring said improved boat docking line for uniformly-repeatable docking by attaching said docking loop to a boat cleat of the boat while the boat is situated at a dock at which the boat is to be docked, before said attaching said first line section to the first mooring fixture and said attaching said second line section to the second mooring fixture; and
said attaching said first line section to the first mooring fixture and said attaching said second line section to the second mooring fixture with a desired preconfigured tautness.

14. The method of claim 12, wherein:
a sum of a free length of said first line section plus a free length of said second line section length is no greater than one-hundred-twenty-five percent (125%) of said fixture separation distance; whereby:
a desired tautness for docking the boat is preconfigured into said boat docking line.

15. The method of claim 14, wherein said docking loop is positioned within five feet of an expected location of a boat cleat to which said docking loop is to be attached when the boat comprising the boat cleat is docked, whereby said docking loop is maintained in a controllably-situated position even while the boat is not docked.

16. The method of claim 12, further comprising omitting a support configured to attach the improved boat docking line to a mooring fixture.

17. The method of claim 16, further comprising omitting an elongate arm configured to be grasped at or near a proximal end by a person and configured such that said omitted support can be attached at or near an opposite distal end so that attachment to the mooring fixture can be carried out by the person at a distance from the mooring fixture.

18. The method of claim 14, wherein said docking loop is positioned within five feet of an expected location of a boat cleat to which said docking loop is to be attached when the boat comprising the boat cleat is docked, whereby said docking loop is maintained in a controllably-situated position even while the boat is not docked.

19. The method of claim 14, further comprising maintaining a stable position for the docked boat by attaching said docking loop to a boat cleat of the boat, due to said sum of said free lengths and said position of said docking loop at said juncture.

20. The method of claim 18, further comprising maintaining a stable position for the docked boat by attaching said docking loop to a boat cleat of the boat, due to said sum of said free lengths and said position of said docking loop at said juncture and said position of said docking loop at said juncture within five feet of the expected location of the boat cleat, whereby said docking loop is maintained in a controllably-situated position even while the boat is not docked.
